(19) United States
(12) Patent Application Publication
(10) Pub. No.: US 2006/0205265 A1
(43) Pub. Date: Sep. 14, 2006

(54) Handheld electronic device with stripping module

(75) Inventor: Chun-Hao Chen, Taipei County (TW)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/110,750

(22) Filed: Apr. 21, 2005

(30) Foreign Application Priority Data
Mar. 9, 2005 (TW) 94107107

(51) Int. Cl. H01R 4/24

(52) U.S. Cl. 439/397

(57) ABSTRACT

A handheld electronic device with a stripping module. The handheld electronic device comprises a main body with an opening, and a stripping module pivoted on the opening and capable of engaging the main body in the opening. The strip is wound around on the stripping module, and thereby attached to the handheld electronic device.

### BACKGROUND

The invention relates to a handheld electronic device with a stripping module, and in particular to a handheld electronic device with a rotatable stripping module.

FIGS. 1a and 1b are schematic views of a conventional handheld electronic device such as mobile phone, personal digital assistant and the like. The handheld electronic device comprises a main body 10 with two adjacent stripping holes 20 on one side thereof. A strip (not shown) is wound around the main body 10 through the stripping holes 20 in the directions shown in FIG. 1b. The size of the stripping hole 20 is limited due to aesthetic considerations, and the strip is mostly made of soft material, therefore, the strip does not easily pass through the stripping holes 20.

### SUMMARY

An embodiment of a handheld electronic device comprises a main body and a stripping module. The main body comprises an opening and an engaging portion disposed in the opening. The stripping module is pivoted on the main body in the opening for a strip wound thereon and also engaged with the main body in the opening. The stripping module comprises a body, an extending portion extending from the body toward the opening, and a hook disposed on the extending portion and engaged with the engaging portion when the stripping module is engaged with the main body in the opening. The body comprises a groove and is capable of deforming in the groove, thereby releasing the hook from the engaging portion. In such a structure, it is easy for a strip to wind around the stripping module and further be secured to the handheld electronic device.

The stripping module further comprises a latch member disposed on the extending portion. The strip is wound around the latch member, whereby the strip is joined to the stripping module when the hook is released from the main body unexpectedly.

The extending portion comprises a central element and a lateral element connecting the body. The central element is thicker than the lateral element. The extending portion is substantially W-shaped.

The main body further comprises an inclined surface disposed on one edge of the opening to facilitate pulling and releasing the stripping module from the main body.

The main body further has a shaft disposed in the opening and the stripping module further comprises a pivot portion joining the shaft, thereby the stripping module is pivoted to the main body.

### BRIEF DESCRIPTION OF THE DRAWINGS

The invention can be more fully understood by reading the subsequent detailed description and examples with references made to the accompanying drawings, wherein:

FIG. 1a is a schematic view of a conventional handheld electronic device;

FIG. 1b is a partially enlarged view of FIG. 1a;

FIG. 2 is a schematic view of an embodiment of a handheld electronic device according to the invention;

FIG. 3 is an enlarged view of portion A of FIG. 2;

FIG. 4 is a schematic view showing a strip passing through a stripping module according to the invention;

FIG. 5 is a schematic view showing the stripping module rotating clockwise and engaging the main body according to the invention;

FIG. 6 shows the stripping module almost engaging the opening according to the invention;

FIG. 7 shows the stripping module engaged with the opening according to the invention;

FIG. 8 shows the stripping module of the invention when the strip is stretched; and

FIG. 9 shows the stripping module as it is released from the opening.

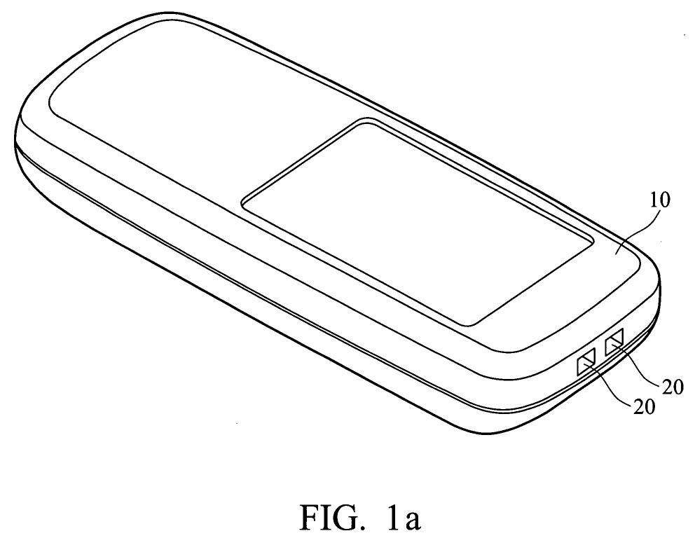

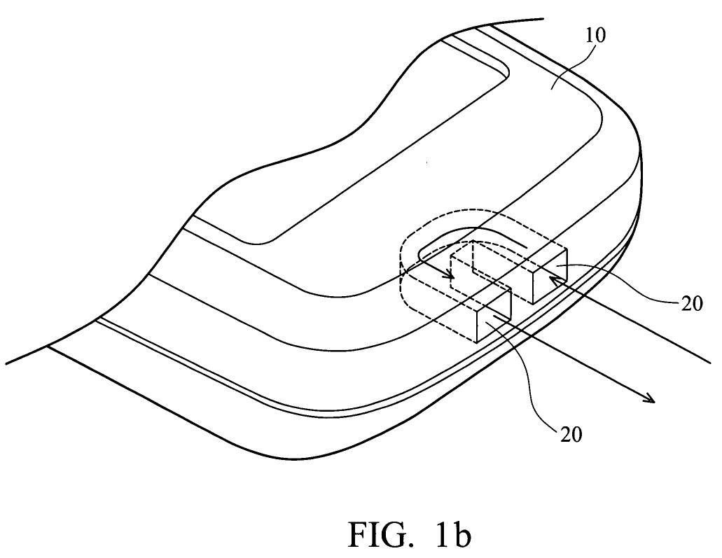

### DETAILED DESCRIPTION

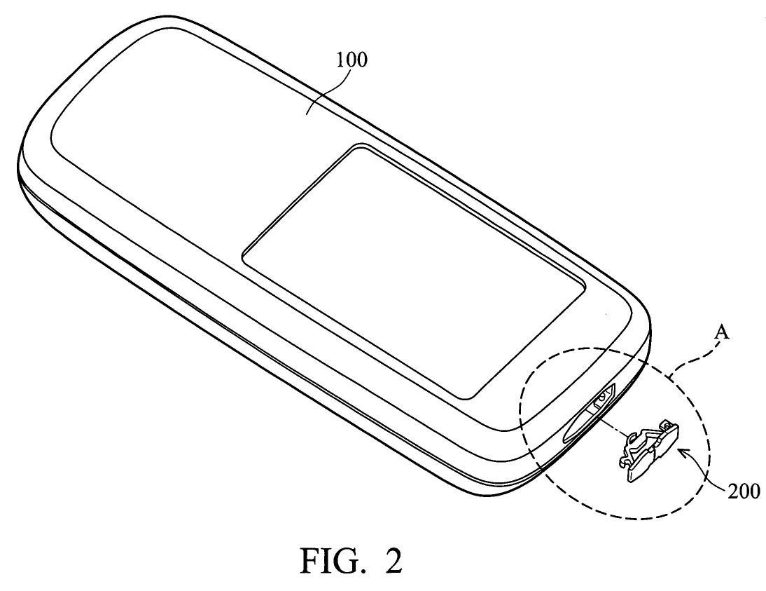

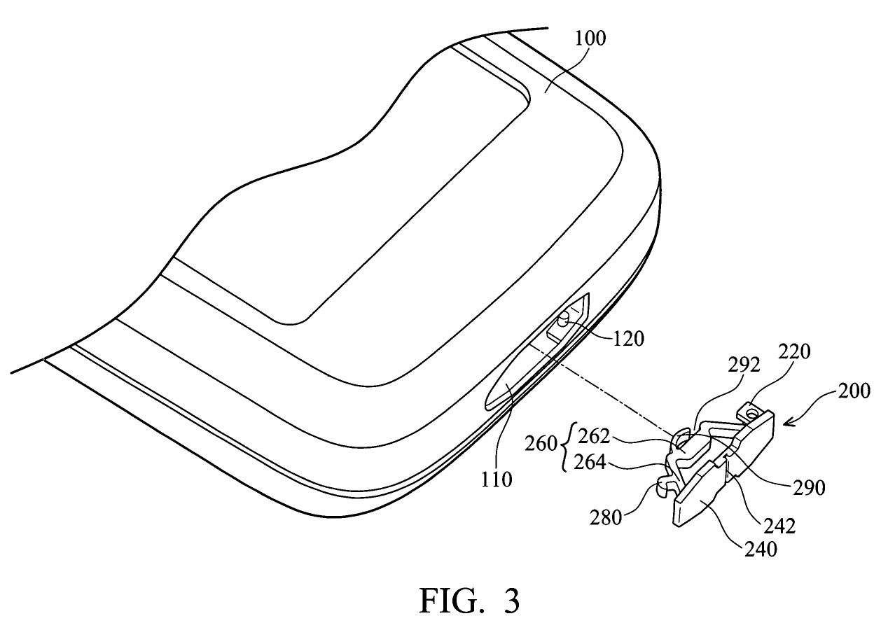

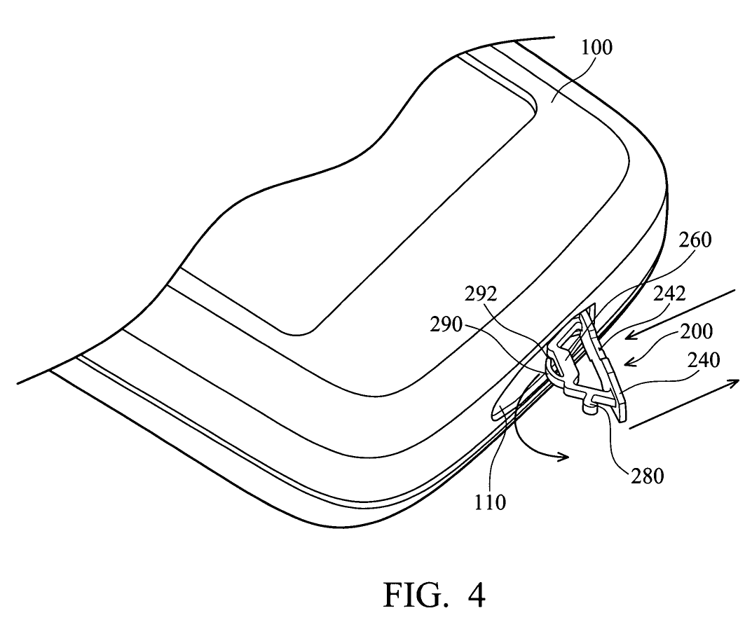

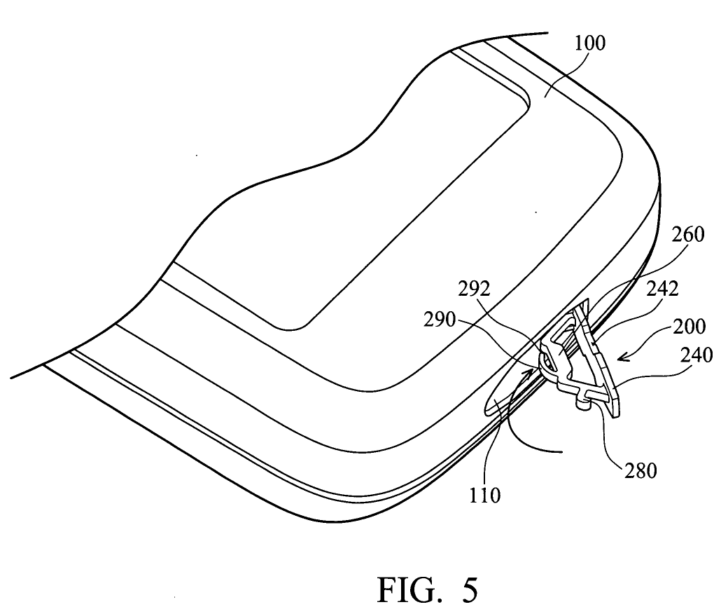

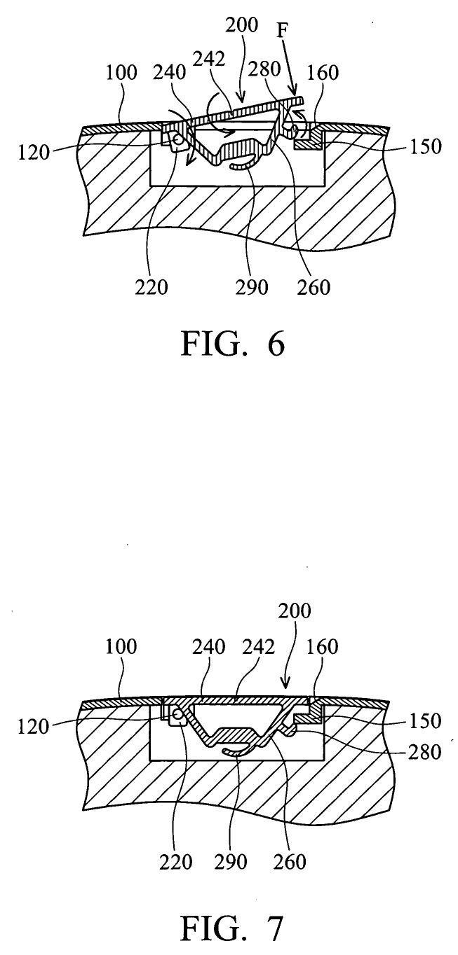

Referring to FIG. 2, a handheld electronic device of the invention comprises a main body 100 and a stripping module 200. In FIG. 3, the main body 100 comprises an opening 110 and a shaft 120 disposed in the opening 110. The stripping module 200 comprises a bearing 220, a body 240, an extending portion 260, a hook 280 and a latch member 290. The bearing 220 is disposed on the body 240 and joins the shaft 120, whereby the stripping module 200 pivots on the opening 110 as shown in FIGS. 4 and 5. Referring to FIGS. 6 to 9, the hook 280 is capable of engaging an engaging portion 150 in the opening 110, thereby the stripping module 200 engages the main body 100 in the opening 110. The body 240 comprises a groove 242 which easily deforms the body 240. When the body 240 deforms in the groove 242, the hook 280 is easily released from the engaging portion 150. The extending portion 260 extends from the body 240 toward the opening 110 while the stripping module is engaged with the main body in the opening and is substantially W-shaped. The extending portion comprises a central element 262 and a lateral element 264 shown in FIG. 3. The central element 262 is thicker than the lateral element 264. The thickness of the extending portion 260 determines the strength which affects the deformation when force is exerted thereon. When the stripping module 200 engages the main body 100, the extending portion is accommodated in the opening 110. The hook 280 is disposed on the lateral element 264 of the extending portion 260. The curved latch member 290 is disposed on the central element 262 of the extending portion 260 far away the bearing 220. A gap 292 exists between the extending portion 260 and the latch member 290.

The arrows in FIG. 4 represent a strip passing through the stripping module 200. The strip winds around the body 240 and extending portion 260 and passes through the gap 292 to be secured between the extending portion 260 and the latch member 290. The arrows in FIG. 5 represent the stripping module 200 rotating clockwise and engaging the main body 100 in the opening 110.

Referring to FIG. 6, the engaging portion 150 is L-shaped and disposed on an inner wall of the opening 110. When the stripping module 200 is about to engage with the main body 100 in the opening 110, the tip of the hook 280 first contacts the engaging portion 150 and is pushed by the engaging portion 150. At this time, the body 240 deforms slightly in the groove 242 to facilitate the tip of the hook 280 passing through the engaging portion 150. When the hook 280 passes through the engaging portion, the body 240 recovers itself. At this time, the hook 280 engages the engaging portion 150, whereby the stripping module 200 engages the main body 100 in the opening 110 as shown in FIG. 7.

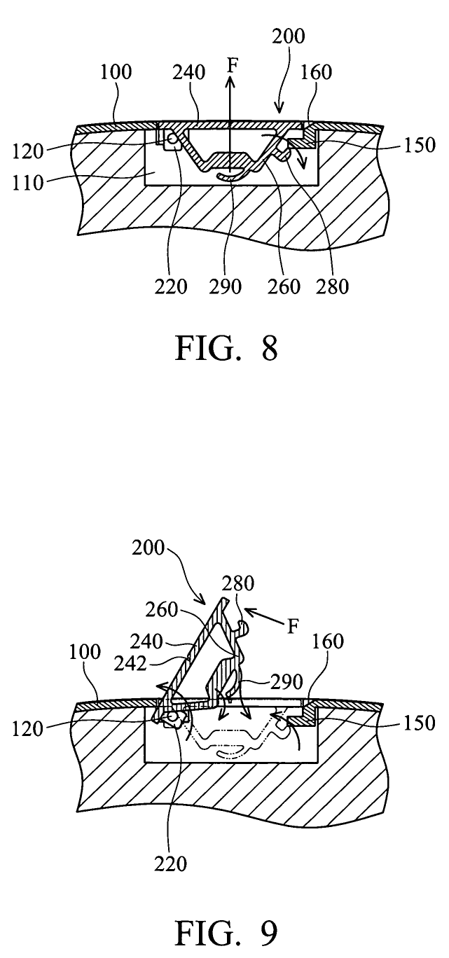

The arrows in FIG. 8 represent the stretching direction of the strip. When the strip is pulled upward, the hook 280 deforms due to interference with the engaging portion 150 and more securely engages the engaging portion 150. This ensures the engagement of the stripping module 200 and the main body 100.

If the stripping module 200 escapes from the main body 100 accidentally, as the strip is wound between the latch member 290 and the extending portion 260, the strip is maintained securely on the stripping module 200.

Referring to FIG. 9, when the strip is removed, the body 240 is pulled and deformed in the groove 242, thereby the hook 280 is released from the engaging portion 150. The stripping module 200 is rotated counterclockwise to leave the opening 110, whereby the strip can be removed from the stripping module 200. An inclined surface 160 is formed on one edge of the opening 110 to facilitate the pull.

Although a mobile phone is described as a preferred embodiment, it is not limit thereto. The stripping module of the invention can be applied to handheld electronic devices such as personal digital assistants (PDAs), MP3 players and the like.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A handheld electronic device, comprising:
a main body having an opening and an engaging portion disposed in the opening; and
a stripping module pivoted on the main body in the opening for a strip wound thereon and engaged with the main body in the opening, comprising:
a body;
an extending portion extending from the body toward the opening; and
a hook disposed on the extending portion and engaged with the engaging portion when the stripping module is engaged with the main body in the opening.

2. The handheld electronic device as claimed in claim 1, wherein the body comprises a groove and deforms in the groove, thereby releasing the hook from the engaging portion.

3. The handheld electronic device as claimed in claim 1, wherein the stripping module further comprises a latch member disposed on the extending portion, in which the strip is wound, whereby the strip is joined to the stripping module when the hook is released from the main body.

4. The handheld electronic device as claimed in claim 1, wherein the extending portion comprises a central element and a lateral element connecting the body, wherein the central element is thicker than the lateral element.

5. The handheld electronic device as claimed in claim 4, wherein the extending portion is substantially W-shaped.

6. The handheld electronic device as claimed in claim 1, wherein the engaging portion is substantially L-shaped.

7. The handheld electronic device as claimed in claim 1, wherein the main body further has an inclined surface disposed on one edge of the opening to facilitate pulling and releasing the stripping module from the main body.

8. The handheld electronic device as claimed in claim 1, wherein the main body further has a shaft disposed in the opening and the stripping module further comprises a pivot portion joining the shaft, thereby the stripping module is pivoted to the main body.

9. The handheld electronic device as claimed in claim 8, wherein pivot portion comprises a bearing joining the shaft.
